(19) United States
(12) Patent Application Publication
(10) Pub. No.: US 2025/0216341 A1
(43) Pub. Date: Jul. 3, 2025

(54) INSPECTION APPARATUS AND INSPECTION METHOD

(71) Applicant: Mitsubishi Electric Corporation, Tokyo (JP)

(72) Inventors: Hiroshi UEDA, Tokyo (JP); Tatsunori YANAGIMOTO, Tokyo (JP); Yoshihisa UCHIDA, Tokyo (JP); Hiroshi IWANAGA, Tokyo (JP)

(73) Assignee: Mitsubishi Electric Corporation, Tokyo (JP)

(21) Appl. No.: 18/919,362

(22) Filed: Oct. 17, 2024

(30) Foreign Application Priority Data
Dec. 28, 2023 (JP) 2023-222217

(51) Int. Cl. G01N 21/95; G06T 7/00; G06T 7/70

(52) U.S. Cl. CPC G01N 21/9501; G06T 7/001; G06T 7/70; G06T 2207/30148

(57) ABSTRACT

An inspection apparatus includes: an imaging apparatus that is disposed above an aluminum wire and captures an image of the aluminum wire in order to obtain two-dimensional position information of the aluminum wire; a coaxial illuminator that is disposed coaxially with the imaging apparatus and applies coaxial illumination light to the aluminum wire; and a control apparatus that obtains, from the image, two-dimensional position information of a region existing on a vertex portion of the aluminum wire and having brighter luminance than a surrounding area and a region existing on a wire bonding portion, which is a bonding portion of the aluminum wire, and having brighter luminance than a surrounding area.

### BACKGROUND OF THE INVENTION

### Field of the Invention

The present disclosure relates to an inspection apparatus and an inspection method.

### Description of the Background Art

Conventionally, a technique for inspecting abnormality in a wire bonding formed as an interconnection between electrodes has been widely proposed.

For example, Japanese Patent Application Laid-Open No. 7-63530 (1995) discloses a method. In the method, coaxial illumination is applied from above a wire, and the wire is imaged while moving an imaging apparatus disposed above the wire in a height direction. Then, a height position of the wire is measured from a brightness distribution of a bright spot on a vertex portion of the imaged wire.

Furthermore, for example, Japanese Patent Application Laid-Open No. 2010-62324 discloses a method. In the method, coaxial illumination is applied from above a wire, and a bright spot on a vertex portion of the wire is detected to calculate two-dimensional coordinates of the vertex portion. Then, a height of the calculated position is measured with a laser displacement meter.

However, in the method described in Japanese Patent Application Laid-Open No. 7-63530 (1995), although the height position of the vertex portion of the wire can be measured, the abnormality in a wire bonding portion, which is a bonding portion of the wire, cannot be detected. Furthermore, in the case of measuring the height position of the vertex portion of the wire, it is necessary to capture a large number of images in order to measure one wire while moving the imaging apparatus in the height direction, and there is a problem that a measurement time is enormous when inspecting a plurality of wires.

Similarly to the above, in the method described in Japanese Patent Application Laid-Open No. 2010-62324, the height position of the vertex portion of the wire can be measured, but the abnormality in a wire bonding portion, which is a bonding portion of the wire, cannot be detected.

### SUMMARY

An object of the present disclosure is to provide a technique capable of detecting abnormality in a wire including a wire bonding portion at a high speed.

An inspection apparatus according to the present disclosure is an inspection apparatus that detects abnormality in an inspection workpiece whose both end portions are wire-bonded to to-be-bonded portions of a semiconductor device by a wedge bonding method. The inspection workpiece is a wire having a diameter of 100 μm or more. The inspection apparatus includes an imaging apparatus, a coaxial illuminator, and a control apparatus. The imaging apparatus is disposed above the wire and captures an image of the wire to obtain two-dimensional position information of the wire. The coaxial illuminator is disposed coaxially with the imaging apparatus, and applies coaxial illumination light to the wire. The control apparatus obtains, from the image, the two-dimensional position information of a region existing on a vertex portion of the wire and having brighter luminance than a surrounding area and a region existing on a wire bonding portion, which is a bonding portion of the wire, and having brighter luminance than a surrounding area.

Since the inspection apparatus can obtain, by a single imaging, the two-dimensional position information of the vertex portion of the wire and the wire bonding portion, an abnormality in the wire including the wire bonding portion can be detected at a high speed using the two-dimensional position information.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view of an inspection apparatus according to a first preferred embodiment;

FIG. 2 is a side view illustrating, in the first preferred embodiment, a bonding state between an aluminum wire as an inspection workpiece and each of a wire connection terminal portion and an electrode, which are to-be-bonded portions;

FIG. 3 is a diagram illustrating an image of a semiconductor device captured from above by an imaging apparatus included in the inspection apparatus according to the first preferred embodiment;

FIG. 4 is a view taken in the direction of arrow A in FIG. 3;

FIG. 5 is a flowchart of an inspection method according to the first preferred embodiment;

FIG. 6 is a side view of an inspection apparatus according to a second preferred embodiment;

FIG. 7 is a side view illustrating a state in which an aluminum wire as an inspection workpiece is floating in the inspection apparatus according to the second preferred embodiment;

FIG. 8 is a flowchart of an inspection method according to the second preferred embodiment;

FIG. 9 is a side view of an inspection apparatus according to a third preferred embodiment;

FIG. 10 is a side view illustrating, in a fourth preferred embodiment, a bonding state between an aluminum wire as an inspection workpiece and each of a wire connection terminal portion and an electrode, which are to-be-bonded portions;

FIG. 11 is a top view illustrating, in the fourth preferred embodiment, a bonding state between an aluminum wire as an inspection workpiece and each of a wire connection terminal portion and an electrode, which are to-be-bonded portions;

FIG. 12 is a flowchart of an inspection method according to the fourth preferred embodiment; and

FIG. 13 is an explanatory diagram for explaining an inspection method according to the fourth preferred embodiment.

### DESCRIPTION OF THE PREFERRED EMBODIMENTS

### First Preferred Embodiment

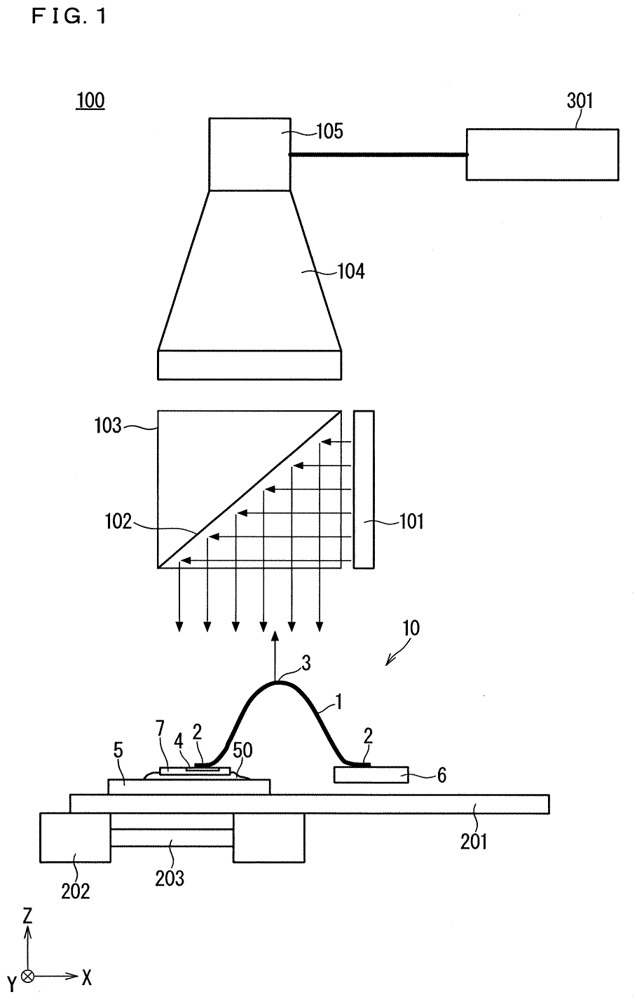

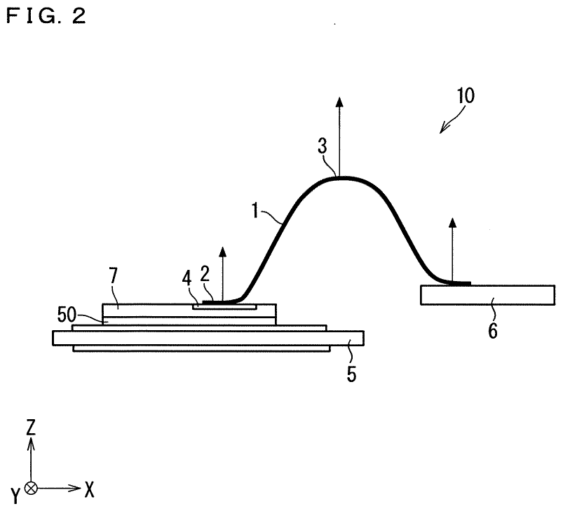

A first preferred embodiment will be described below with reference to the drawings. FIG. 1 is a side view of an inspection apparatus 100 according to the first preferred embodiment. FIG. 2 is a side view illustrating, in the first preferred embodiment, a bonding state between an aluminum wire 1 and each of a wire connection terminal portion 4 and an electrode 6.

In FIG. 1, an X direction, a Y direction, and a Z direction are orthogonal to each other. The X direction, the Y direction, and the Z direction illustrated in the following drawings are also orthogonal to each other. Hereinafter, a direction including the X direction and a −X direction, which is the direction opposite to the X direction, is also referred to as “X-axis direction”. In addition, a direction including the Y direction and a −Y direction, which is the direction opposite to the Y direction, is also referred to as “Y-axis direction”. In addition, a direction including the Z direction and a −Z direction, which is the direction opposite to the Z direction, is also referred to as “Z-axis direction”.

As illustrated in FIG. 1, the inspection apparatus 100 detects abnormality in an inspection workpiece whose both end portions are wire-bonded to to-be-bonded portions of a semiconductor device 10 by a wedge bonding method. The inspection apparatus 100 includes an inspection stage 201, a motor 202, a ball screw 203, an imaging apparatus 105, a coaxial illuminator 103, and a control apparatus 301.

On an upper surface (a surface in the Z direction) of the inspection stage 201, there is placed a semiconductor device 10 including an aluminum wire 1 (corresponding to a wire), which is the inspection workpiece. Note that FIG. 1 illustrates a part of the semiconductor device 10. The inspection stage 201 is coupled to the motor 202 and the ball screw 203, and can move in the X-axis direction by being driven by the motor 202. Although not illustrated, the inspection stage 201 is also coupled to a motor for Y-axis driving and a ball screw, and can move also in the Y-axis direction by being driven by the motor for Y-axis driving. Here, the inspection stage 201, the motor 202, and the ball screw 203 correspond to a moving mechanism that moves the semiconductor device 10 in a two-dimensional direction (X-axis direction and Y-axis direction).

Next, the semiconductor device 10 will be described. As illustrated in FIGS. 1 and 2, the semiconductor device 10 includes a substrate 5, an electrode 6, a semiconductor chip 7, and the aluminum wire 1 having a diameter of 100 μm or more. The semiconductor chip 7 is mounted on an upper surface (a surface in the Z direction) of the substrate 5 via a solder 50. One end portion of the aluminum wire 1 is wire-bonded, by a wedge bonding method, on (in the Z direction) the wire connection terminal portion 4 formed on the semiconductor chip 7. The other end portion of the aluminum wire 1 is wire-bonded on (in the Z direction) the electrode 6 by a wedge bonding method.

Here, the main material of the substrate 5 may be a substrate made of metal such as copper or aluminum, or may be a substrate obtained by bonding a metal sheet to one side or both sides of a substrate of an insulator. Furthermore, similarly to the above, the main material of the electrode 6 may be a substrate made of metal such as copper or aluminum, or may be a substrate obtained by bonding a metal sheet to one side or both sides of a substrate of an insulator.

In the wedge bonding method, the aluminum wire 1 has a wire bonding portion 2, which is a bonding portion with the to-be-bonded portion of the semiconductor device 10, and a vertex portion 3, which is a vertex in the Z direction. The to-be-bonded portion of the semiconductor device 10 is the wire connection terminal portion 4 of the semiconductor chip 7 or the electrode 6.

The description returns to the inspection apparatus 100. As illustrated in FIG. 1, the imaging apparatus 105 is disposed above (in the Z direction) the aluminum wire 1. The imaging apparatus 105 includes an optical lens 104 that forms an image of the semiconductor device 10 including the aluminum wire 1, and captures the image formed by the optical lens 104 in order to obtain two-dimensional position information of the aluminum wire 1. Here, the two-dimensional position information is position information of two-dimensional coordinates (XY coordinates).

The coaxial illuminator 103 is disposed between the aluminum wire 1 and the imaging apparatus 105 and coaxially with the imaging apparatus 105. The coaxial illuminator 103 includes a half mirror 102 and an illumination light source 101, and vertically applies coaxial illumination light to the semiconductor device 10 including the aluminum wire 1 from above (in the Z direction) using the half mirror 102 and the illumination light source 101.

The control apparatus 301 acquires an image captured by the imaging apparatus 105 and appropriately performs arithmetic processing. More specifically, the control apparatus 301 performs arithmetic processing to obtain, from the image, two-dimensional position information of a region existing on the vertex portion 3 of the aluminum wire 1 and having brighter luminance than a surrounding area and a region existing on the wire bonding portion 2, which is a bonding portion of the aluminum wire 1, and having brighter luminance than a surrounding area. The control apparatus 301 controls each unit of the inspection apparatus 100. Note that the inspection apparatus 100 may include, separately from the control apparatus 301, a control apparatus that controls each unit of the inspection apparatus 100.

The control apparatus 301 includes a processor (not illustrated) and a memory (not illustrated). The above-described functions of the control apparatus 301 are described in a program, and the functions of the control apparatus 301 are implemented by the processor executing the program.

As illustrated in FIG. 1, in a case where wire bonding is performed by a wedge bonding method using the aluminum wire 1 having a diameter of 100 μm or more, ultrasonic bonding is performed while pressing the aluminum wire 1 from above (in the Z direction) in a state where the aluminum wire 1 is in a lying position. This establishes a state where a flat region exists on a surface (surface in the Z direction) of each wire bonding portion 2.

When the coaxial illumination light (hereinafter, also simply referred to as “illumination light”) radiated by the coaxial illuminator 103 illuminates the aluminum wire 1, the surfaces (the surfaces in the Z direction) of the vertex portion 3 and the wire bonding portion 2 each have a portion perpendicular to the illumination direction of the illumination light, so that the coaxial illumination light is reflected in a direction opposite to the illumination direction, in other words, is reflected toward the imaging apparatus 105. Therefore, when the aluminum wire 1 is imaged by the imaging apparatus 105, luminance of the aluminum wire 1 is dark as a whole, and the vertex portion 3 and the wire bonding portion 2 are observed, in the dark area, as regions having brighter luminance than the surrounding area.

On the other hand, in a case where wire bonding is performed using an aluminum wire 1 having a diameter of less than 100 μm, a deformed portion on the surface (surface in the Z direction) of the aluminum wire 1 is larger; therefore, a region perpendicular to the light irradiation direction is smaller, and a region having bright luminance is accordingly smaller. Therefore, it is difficult to detect the wire bonding portion 2 by using an image. For this reason, the diameter of the aluminum wire 1 is desirably 100 μm or more.

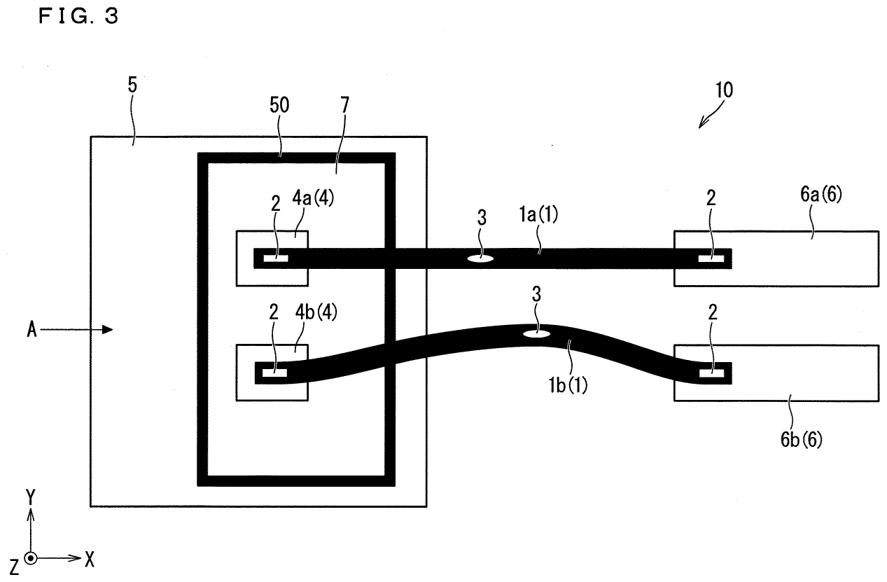

FIG. 3 is a diagram illustrating an image of the semiconductor device 10 captured from above (in the Z direction) by the imaging apparatus 105 included in the inspection apparatus 100 according to the first preferred embodiment.

As illustrated in FIG. 3, two aluminum wires 1a, 1b are disposed on the upper surface (surface in the Z direction) of the substrate 5. The aluminum wire 1a has wire bonding portions 2 in which both end portions of the aluminum wire 1a are wire-bonded by a wedge bonding method, and both end portions of the aluminum wire 1a are respectively joined to a wire connection terminal portion 4a and an electrode 6a.

Similarly to the aluminum wire 1a, the aluminum wire 1b has wire bonding portions 2 in which both end portions of the aluminum wire 1b are wire-bonded by a wedge bonding method, and both end portions of the aluminum wire 1b are respectively joined to a wire connection terminal portion 4b and an electrode 6b. A loop portion of the aluminum wire 1b is inclined sideways by receiving an external force after the aluminum wire 1b was wire-bonded.

Since illumination light is applied perpendicularly from the direction directly above (in the Z direction) the aluminum wires 1a, 1b by the coaxial illuminator 103, the vertex portions 3 of the two aluminum wires 1a, 1b and the wire bonding portions 2 are observed, in the captured image, as regions having bright luminance. On the other hand, since there is almost no horizontal region in the aluminum wires 1a, 1b as a whole, regions having low luminance as a whole are observed except for the vertex portions 3 and the wire bonding portions 2.

Normally, when two points are connected with an aluminum wire, the aluminum wire has a linear shape like the aluminum wire 1a, and the wire bonding portions 2 and the vertex portion 3 are aligned on a straight line. On the other hand, in the case where the loop portion has inclined sideways by receiving an external force like the aluminum wire 1b, the wire bonding portions 2 and the vertex portion 3 are not aligned on a straight line, and the position of the vertex portion 3 is shifted from the straight line connecting the two wire bonding portions 2 in terms of positional relationship.

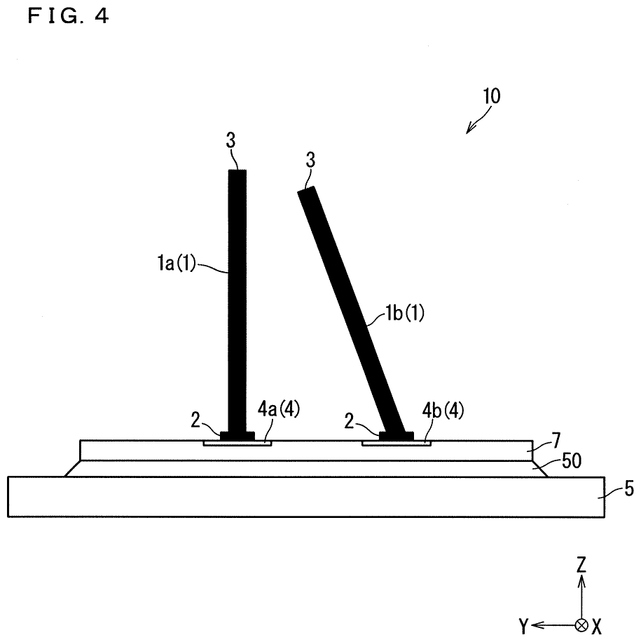

FIG. 4 is a view taken in the direction of arrow A in FIG. 3. In the drawing, the electrodes 6a, 6b are not illustrated for easy understanding of the description.

As illustrated in FIG. 4, the following fact can be seen. Regarding the aluminum wire 1a, the loop is vertically formed from the wire bonding portion 2 to the vertex portion 3; however, regarding the aluminum wire 1b, the loop is formed obliquely from the wire bonding portion 2 to the vertex portion 3, in other words, the loop has a shape inclined sideways.

In addition, as illustrated in FIGS. 3 and 4, when the aluminum wire is inclined sideways, the distance between the vertex portion 3 of the aluminum wire 1a and the vertex portion 3 of the aluminum wire 1b is shorter. Therefore, by measuring the two-dimensional distance between regions that are respectively located at the vertex portion 3 of the aluminum wire 1a and the vertex portion 3 of the aluminum wire 1b and have bright luminance, it can be detected that the aluminum wire 1a and the aluminum wire 1b are close to each other. Since it is possible to inspect from an image including a large area captured by the imaging apparatus 105, the plurality of aluminum wires 1a, 1b can be inspected collectively in a short time.

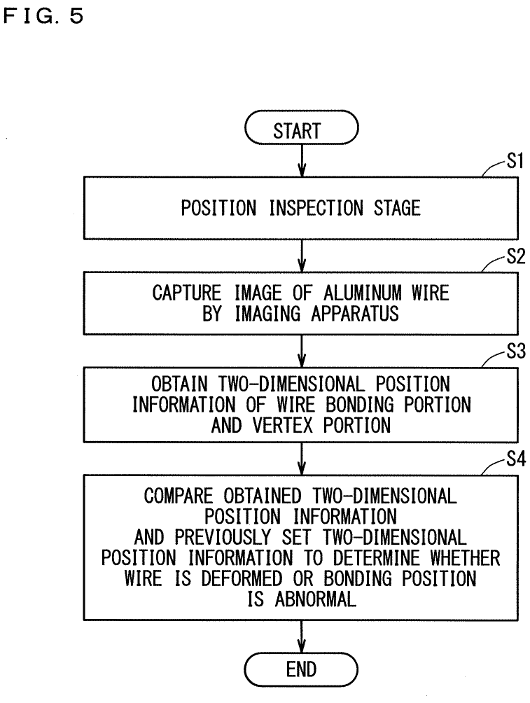

Next, an inspection method according to the first preferred embodiment will be described. FIG. 5 is a flowchart of the inspection method according to the first preferred embodiment.

As illustrated in FIG. 5, first, the control apparatus 301 positions the inspection stage 201 at a predetermined position (step S1), and captures an image of the aluminum wire 1 by the imaging apparatus 105 (step S2). The control apparatus 301 obtains, from the image captured by the imaging apparatus 105, two-dimensional position information of a region existing on the wire bonding portion 2 and having bright luminance and a region existing on the vertex portion 3 and having bright luminance (step S3).

Next, the control apparatus 301 compares the obtained two-dimensional position information with two-dimensional position information previously set in the memory of the control apparatus 301, and when there is a certain difference or more, the control apparatus 301 determines that the wire is deformed or that the bonding position is abnormal (step S4).

Hereinafter, a determination method related to wire deformation or abnormality in the bonding position will be described in detail. The control apparatus 301 calculates, from the captured image, a center of gravity of the region existing on the wire bonding portion 2 and having bright luminance and a center of gravity of the region existing on the vertex portion 3 and having bright luminance, and calculates a two-dimensional distance between the former center of gravity and the latter center of gravity. The control apparatus 301 compares the obtained two-dimensional distance with a two-dimensional distance between the wire bonding portion 2 and the vertex portion 3 previously set in the memory of the control apparatus 301, and when there is a certain difference or more, the control apparatus 301 determines that the wire is deformed or that the bonding position is abnormal.

Alternatively, the following method may be employed. The regions existing on the wire bonding portion 2 and the vertex portion 3 and having bright luminance are each surrounded by a rectangle having the minimum area, the centers of the rectangles are respectively set as the wire bonding portion 2 and the vertex portion 3, and the two-dimensional distance between the wire bonding portion 2 and the vertex portion 3 is compared with a two-dimensional distance between the wire bonding portion 2 and the vertex portion 3 previously set in the memory of the control apparatus 301.

Alternatively, a comparison may be performed between the distance between the pixels that are closest to each other and each of which is in one of regions existing on the wire bonding portion 2 and the vertex portion 3 and having bright luminance and a two-dimensional distance between the wire bonding portion 2 and the vertex portion 3 previously set in the memory of the control apparatus 301.

As described above, the inspection apparatus 100 according to the first preferred embodiment includes: the imaging apparatus 105 that is disposed above (in the Z direction) the aluminum wire 1 and captures an image of the aluminum wire 1 in order to obtain two-dimensional position information of the aluminum wire 1; the coaxial illuminator 103 that is disposed coaxially with the imaging apparatus 105 and applies coaxial illumination light to the aluminum wire 1; and the control apparatus 301 that obtains, from the image, two-dimensional position information of the region existing on the vertex portion 3 of the aluminum wire 1 and having brighter luminance than the surrounding area and the region existing on the wire bonding portion 2, which is the bonding portion of the aluminum wire 1, and having brighter luminance than the surrounding area.

Specifically, the control apparatus 301 compares the obtained two-dimensional position information of the region existing on the vertex portion 3 and having brighter luminance than the surrounding area and of the region existing on the wire bonding portion 2 and having brighter luminance than the surrounding area and the previously set two-dimensional position information of the vertex portion 3 and the wire bonding portion 2; and when there is a certain difference or more, the control apparatus 301 determines that the wire is deformed or that the bonding position is abnormal.

Therefore, since the inspection apparatus 100 can obtain, by a single imaging operation, the two-dimensional position information of the vertex portion 3 of the aluminum wire 1 and the wire bonding portion 2, abnormality in the aluminum wire 1 including the wire bonding portion 2 can be detected at a high speed using the two-dimensional position information.

Furthermore, as illustrated in FIGS. 3 and 4, the control apparatus 301 can detect that the aluminum wire 1a and the aluminum wire 1b are close to each other by obtaining, from the image, the two-dimensional position information of the regions existing on the vertex portions 3 of the plurality of aluminum wires 1a, 1b and having brighter luminance than the surrounding areas, measuring, from the obtained two-dimensional position information, the distance between the plurality of vertex portions 3 of the plurality of aluminum wires 1a, 1b, and comparing the measured distance between the vertex portions 3 with the previously set distance between the plurality of vertex portions 3. As a result, the possibility of contact between the adjacent aluminum wires 1a, 1b can be detected. In addition, in the case of inspecting the plurality of aluminum wires 1a, 1b, since it is possible to inspect from an image including a large area captured by the imaging apparatus 105, the plurality of aluminum wires 1a, 1b can be inspected collectively in a short time.

### <Modification of First Preferred Embodiment>

The aluminum wire 1 may be a metal thin wire whose main material contains, other than aluminum, copper, gold, silver or the like, which can be wire-bonded by a wedge bonding method.

Furthermore, the position where an image is to be captured is determined by the inspection stage 201 moving in the two-dimensional direction; however, the imaging apparatus 105 and the coaxial illuminator 103 may be structured to move in the two-dimensional direction so that the position where an image is to be captured is determined by the imaging apparatus 105 and the coaxial illuminator 103 moving in the two-dimensional direction.

Furthermore, the inspection stage 201 is configured to be movable by the motor 202 and the ball screw 203, but may be configured to use a linear motor.

Furthermore, the inspection stage 201 may be structured to move in the height direction (Z-axis direction) in order to adjust the focus of the imaging apparatus 105, or the imaging apparatus 105 may be structured to move in the height direction (Z-axis direction).

Although one end portion of the aluminum wire 1 is bonded to the wire connection terminal portion 4 on (in the Z direction) the semiconductor chip 7 and the other end portion is bonded to the electrode 6, the to-be-bonded portion of the semiconductor device 10 is not limited thereto, and any material may be used as long as the material can be wire-bonded by a wedge bonding method.

### Second Preferred Embodiment

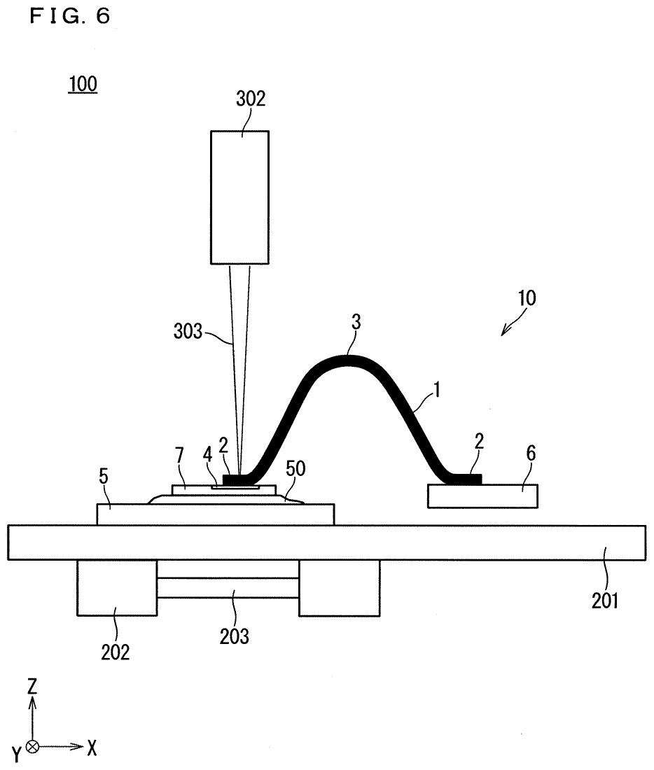

Next, an inspection apparatus 100 according to a second preferred embodiment will be described. FIG. 6 is a side view of the inspection apparatus 100 according to the second preferred embodiment. Note that, in the second preferred embodiment, the same components as those described in the first preferred embodiment are assigned the same reference signs, and the description thereof will be omitted.

In the second preferred embodiment, the inspection apparatus 100 further includes, as illustrated in FIG. 6, a laser displacement meter 302 in addition to the configuration of the first preferred embodiment. The laser displacement meter 302 is disposed above (in the Z direction) the aluminum wire 1.

The control apparatus 301 (see FIG. 1) moves the inspection stage 201 in the two-dimensional direction with respect to the detected position of the wire bonding portion 2 on the two-dimensional coordinates, thereby performing positioning such that the wire bonding portion 2 is just irradiated with a laser 303 radiated by the laser displacement meter 302. By this operation, information of the height position of the wire bonding portion 2 is obtained. In FIG. 6, the laser displacement meter 302 measures the position of the wire bonding portion 2 on (in the Z direction) the wire connection terminal portion 4, and it is possible to measure, in a similar manner, also the position of the wire bonding portion 2 on (in the Z direction) the electrode 6.

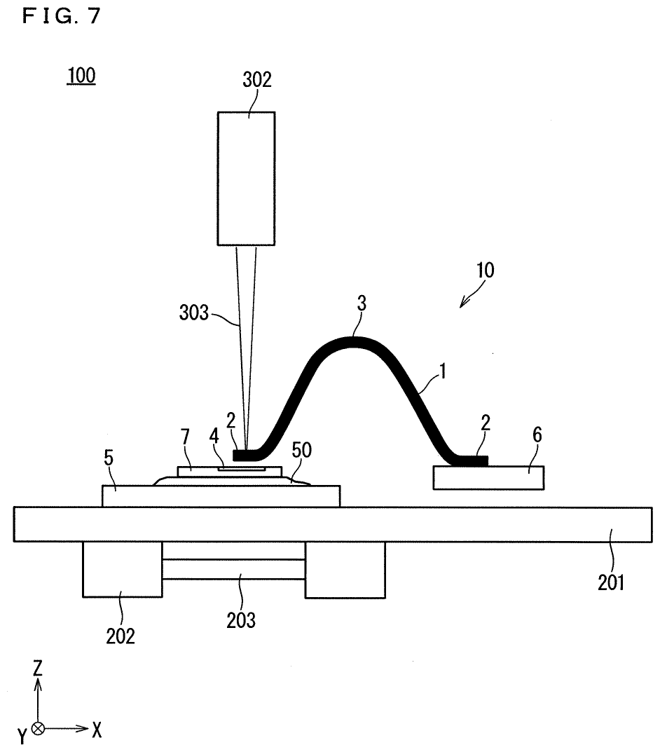

FIG. 7 is a side view illustrating a state in which the aluminum wire 1 is floating in the inspection apparatus 100 according to the second preferred embodiment. As illustrated in FIG. 7, one end side (−X side) of the wire bonding portion 2 of the aluminum wire 1 is slightly floating from the wire connection terminal portion 4. The amount of floating is, for example, about 10 μm or more and several tens μm. In such a state, only by observing from above (in the Z direction), it is difficult to determine whether the wire bonding portion 2 is in a floating state.

As a reason for causing such a state, the following is considered: the surface (surface in the Z direction) of the wire connection terminal portion 4 is contaminated at the time of wire bonding, or wire bonding is performed with a foreign substance being caught, so that the aluminum wire 1 and the wire connection terminal portion 4 are not physically bonded; or separation or the like has occurred after wire bonding, so that the wire bonding portion 2 is floating slightly above the wire connection terminal portion 4.

A height position of the wire bonding portion 2 in a state where the wire bonding portion 2 is floating as described above is higher than the height position when the wire bonding portion 2 is normally wire-bonded. Therefore, by measuring the height position of the wire bonding portion 2 by the laser displacement meter 302, it is possible to detect an abnormal bonding between the aluminum wire 1 and the wire connection terminal portion 4.

Note that if a reference of the height position of the wire bonding portion 2 is set in absolute coordinates, the height position of the wire bonding portion 2 is affected by an inclination of the inspection stage 201, a thickness variation of a substrate 5, and warping of the substrate 5; therefore, it is desirable to set, as the reference, a height position of a surface (surface in the Z direction) of the wire connection terminal portion 4 as close as possible to the wire bonding portion 2.

Furthermore, although not illustrated, if the laser displacement meter 302 uses a method in which a distance to a position irradiated with the laser 303 is measured by triangulation, multiple reflection from a surrounding metal surface can be measured in some cases, so that there is a high possibility of erroneous measurement. Therefore, the laser displacement meter 302 is desirably a laser displacement meter of a confocal method in which a distance is measured from a color (wavelength) of reflected light.

Furthermore, the laser 303 of the laser displacement meter 302 may be of a type with a spot shape to measure a local point, or may be of a type with a linear shape to measure a height position in a linear-shaped region.

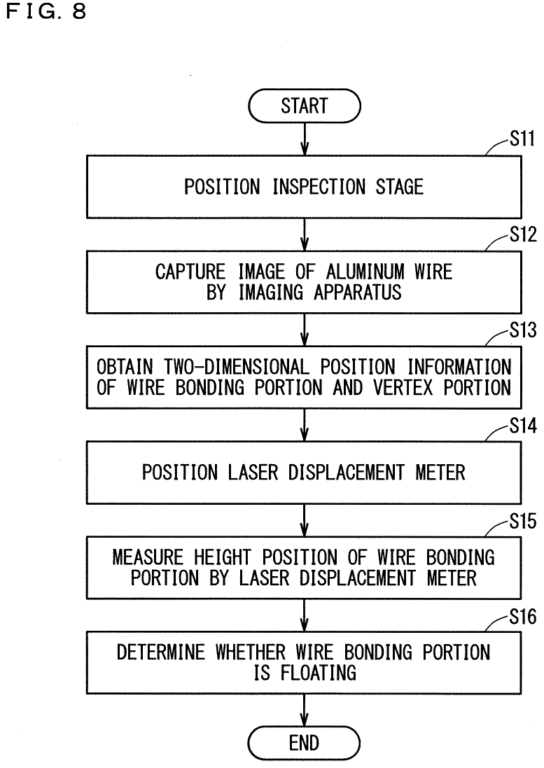

Next, an inspection method according to the second preferred embodiment will be described. FIG. 8 is a flowchart of the inspection method according to the second preferred embodiment.

As illustrated in FIG. 8, first, the control apparatus 301 positions the inspection stage 201 at a predetermined position (step S11), and captures an image of the aluminum wire 1 by the imaging apparatus 105 (step S12). The control apparatus 301 obtains, from the image captured by the imaging apparatus 105, two-dimensional position information of a region existing on the wire bonding portion 2 and having bright luminance and a region existing on the vertex portion 3 and having bright luminance (step S13).

The control apparatus 301 positions the laser displacement meter 302 such that the laser 303 of the laser displacement meter 302 is applied to the position represented by the obtained two-dimensional position information of the wire bonding portion 2 (step S14). Specifically, by moving the inspection stage 201 in the two-dimensional direction, the control apparatus 301 positions the laser displacement meter 302.

Next, the laser displacement meter 302 applies the laser 303 to the region existing on the wire bonding portion 2 and having bright luminance, thereby the measuring a height position of the wire bonding portion 2 (step S15).

Next, the control apparatus 301 determines whether the wire bonding portion 2 is floating (step S16). Specifically, the control apparatus 301 compares the measured height position of the wire bonding portion 2 with a height position of the wire bonding portion 2 previously set in the memory of the control apparatus 301, and when a comparison result is within a predetermined range, the control apparatus 301 determines that the wire bonding portion 2 is not floating and normal, and when the comparison result is outside the predetermined range, the control apparatus 301 determines that the wire bonding portion 2 is floating and is abnormal.

As described above, the inspection apparatus 100 according to the second preferred embodiment further includes: the laser displacement meter 302 that is disposed above (in the Z direction) the aluminum wire 1 and measures the height position of the aluminum wire 1; and the moving mechanism that moves the semiconductor device 10 in the two-dimensional direction. The moving mechanism moves the semiconductor device 10 such that the laser displacement meter 302 is positioned above (in the Z direction) the wire bonding portion 2, and the laser displacement meter 302 measures the height position of the wire bonding portion 2 by applying the laser 303 to the region existing on the wire bonding portion 2 and having brighter luminance than the surrounding area.

Therefore, it is possible to detect floating of the wire bonding portion 2 that is difficult to determine only by observing the appearance.

### <Modification of Second Preferred Embodiment>

In the second preferred embodiment, the laser displacement meter 302 is positioned by the inspection stage 201 moving in the two-dimensional direction. However, the laser displacement meter 302 may be structured to be movable in the two-dimensional direction, and the laser displacement meter 302 may move in the two-dimensional direction to position the laser displacement meter 302 itself. Furthermore, the inspection stage 201 may be structured to be movable in the height direction (Z-axis direction) to adjust a measurement distance of the laser displacement meter 302, or the laser displacement meter 302 may be structured to be movable in the height direction (Z-axis direction).

### Third Preferred Embodiment

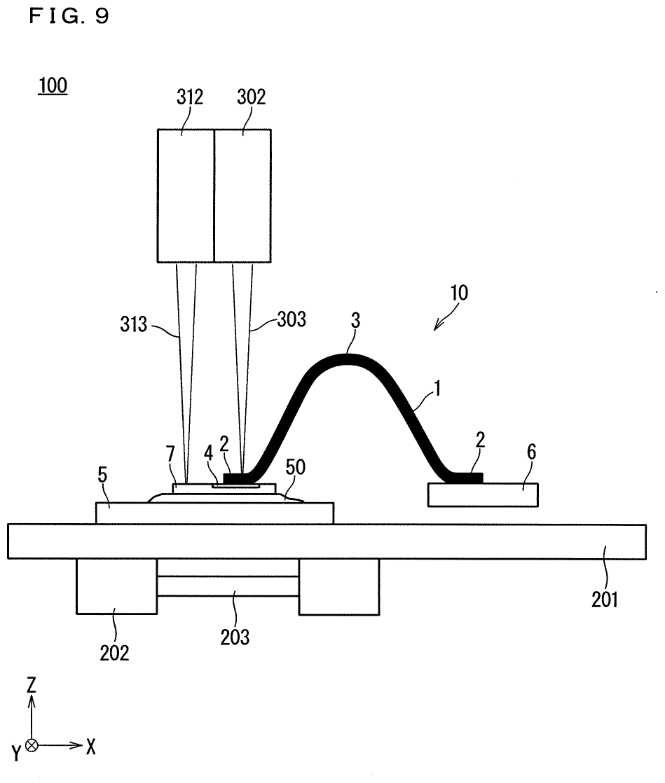

Next, an inspection apparatus 100 according to a third preferred embodiment will be described. FIG. 9 is a side view of the inspection apparatus 100 according to the third preferred embodiment. Note that, in the third preferred embodiment, the same components as those described in the first and second preferred embodiments are assigned the same reference signs, and the description thereof will be omitted.

In the third preferred embodiment, the inspection apparatus 100 further includes, as illustrated in FIG. 9, a laser displacement meter 312 in addition to the configuration of the second preferred embodiment. Specifically, the inspection apparatus 100 includes two laser displacement meters 302, 312. The two laser displacement meters 302, 312 are arranged in line in the X-axis direction. The laser displacement meter 302 is disposed above (in the Z direction) the aluminum wire 1, and the laser displacement meter 312 is disposed above (in the Z direction) a portion, of the semiconductor device 10, located in the vicinity of the wire bonding portion 2. The portion, of the semiconductor device 10, located in the vicinity of the wire bonding portion 2 is an electrode 6 of the semiconductor device 10, a semiconductor chip 7, or a substrate 5. Note that, in FIG. 9, the laser displacement meter 312 is disposed above (in the Z direction) the semiconductor chip 7.

By moving the inspection stage 201 in the two-dimensional direction with respect to the position of the wire bonding portion 2 on the two-dimensional coordinates detected by the coaxial illuminator 103, the wire bonding portion 2 is positioned so as to be just irradiated with the laser 303 radiated by the laser displacement meter 302.

A laser 313 simultaneously radiated by the laser displacement meter 312 is applied to a surface of the semiconductor chip 7, which is a portion, of the semiconductor device 10, located in the vicinity of the wire bonding portion 2, and it is possible to simultaneously measure the height position of the wire bonding portion 2 and the height position, of the semiconductor chip 7, located in the vicinity of the wire bonding portion 2.

Note that, since the inspection method according to the third preferred embodiment is the same as in the case of the second preferred embodiment except that the wire bonding portion 2 and the portion, of the semiconductor device 10, located in the vicinity of the wire bonding portion 2 are simultaneously measured, the description thereof will be omitted.

In the second preferred embodiment, it is necessary to move the inspection stage 201 in order to measure both the height position of the wire bonding portion 2 and the height position of the portion, of the semiconductor device 10, located in the vicinity of the wire bonding portion 2 serving as a reference height position.

In contrast, the inspection apparatus 100 according to the third preferred embodiment includes the laser displacement meters 302, 312. The two laser displacement meters 302, 312 measure, by measuring the height position of the wire bonding portion 2 while applying the laser 303 of one laser displacement meter 302 to the portion existing on the wire bonding portion 2 and having brighter luminance than the surrounding area, and at the same time, measuring the height position of the to-be-bonded portion while applying the laser 313 of the other laser displacement meter 312 to the portion, of the semiconductor device 10, located near the wire bonding portion 2, the difference between the height position of the wire bonding portion 2 and the height position of the portion of the semiconductor device 10.

Therefore, it is possible to simultaneously measure the height position of the wire bonding portion 2 and the reference height position without moving the inspection stage 201. As a result, it is possible to shorten an inspection time for inspecting whether the wire bonding portion 2 is floating.

### <Modification of Third Preferred Embodiment>

In the third preferred embodiment, the laser displacement meters 302, 312 are positioned by the inspection stage 201 moving in the two-dimensional direction. However, the laser displacement meters 302, 312 may be structured to be movable in the two-dimensional direction, and the laser displacement meters 302, 312 may move in the two-dimensional direction to position the laser displacement meters 302, 312 themselves. Furthermore, the inspection stage 201 may be structured to be movable in the height direction (Z-axis direction) to adjust measurement distances of the laser displacement meters 302, 312, or the laser displacement meters 302, 312 may be structured to be movable in the height direction (Z-axis direction).

### Fourth Preferred Embodiment

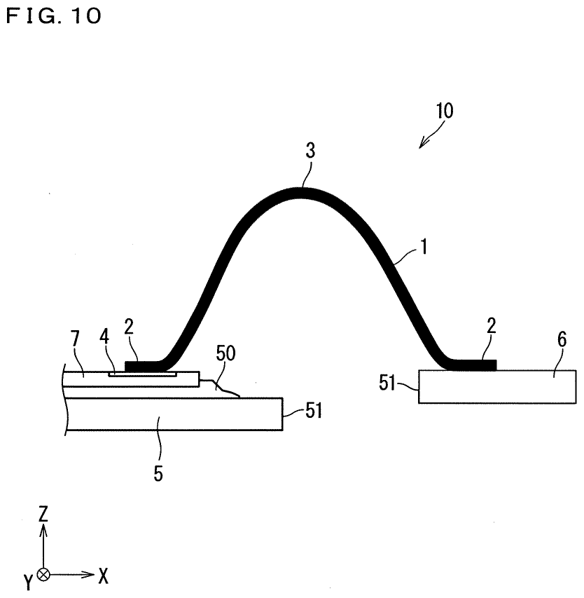

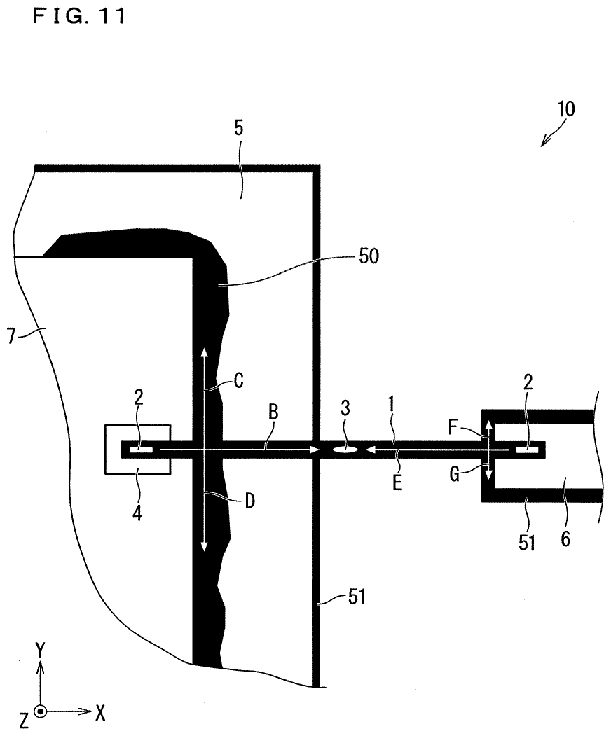

Next, an inspection apparatus 100 according to a fourth preferred embodiment will be described. FIG. 10 is a side view illustrating, in the fourth preferred embodiment, a bonding state between the aluminum wire 1 and each of the wire connection terminal portion 4 and the electrode 6. FIG. 11 is a top view illustrating, in the fourth preferred embodiment, a bonding state between the aluminum wire 1 and each of the wire connection terminal portion 4 and the electrode 6. Note that, in the fourth preferred embodiment, the same components as those described in the first to third preferred embodiments are assigned the same reference signs, and the description thereof will be omitted.

In the first preferred embodiment, comparison is performed between the obtained two-dimensional position information of the region existing on the vertex portion 3 and having brighter luminance than the surrounding area and of the region existing on the wire bonding portion 2 and having brighter luminance than the surrounding area and the two-dimensional position information of the vertex portion 3 and the wire bonding portion 2 previously set in the memory of the control apparatus 301; and when there is a certain difference or more, the control apparatus 301 determines that the wire is deformed or that the bonding position is abnormal.

In contrast, an object of the fourth preferred embodiment is to accurately grasp the entire shape of the aluminum wire 1 in order to perform inspection more accurately than in the case of the first preferred embodiment. The configuration of the inspection apparatus 100 according to the fourth preferred embodiment is similar to that in the case of the first preferred embodiment.

The necessity of accurately grasping the entire shape of the aluminum wire 1 will be described. As illustrated in FIG. 10, the semiconductor chip 7 is mounted on the upper surface (the surface in the Z direction) of the substrate 5 via the solder 50. One end portion of the aluminum wire 1 is wire-bonded, by a wedge bonding method, on (in the Z direction) the wire connection terminal portion 4 formed on the semiconductor chip 7. The other end portion of the aluminum wire 1 is wire-bonded on (in the Z direction) the electrode 6 by a wedge bonding method.

As illustrated in FIG. 11, similarly to the case of FIG. 3, since the illumination light applied from the coaxial illuminator 103 (see FIG. 1) is reflected on the wire bonding portions 2 and the vertex portion 3, the wire bonding portions 2 and the vertex portion 3 each have, in an area having dark luminance, a region having bright luminance; therefore, it is possible to measure, from an image, two-dimensional position information of each region having bright luminance.

Similarly to the case of FIG. 3, the entire aluminum wire 1 is observed, from the image, as a region having dark luminance as a whole. However, the solder 50 protruding to the periphery of the semiconductor chip 7 and outlines 51 of three-dimensional objects are also observed, from an image, as regions having dark luminance, and it is difficult to grasp the entire shape of the aluminum wire 1 on the basis of only brightness in luminance. Here, the three-dimensional objects are the substrate 5 and the electrode 6.

To address this issue, in the fourth preferred embodiment, the entire shape of the aluminum wire 1 is grasped by tracking regions each of which continues from one of the wire bonding portions 2, which are regions existing on the both end portions of the aluminum wire 1 and having brighter luminance than surrounding areas, toward a region existing on the vertex portion 3 and having brighter luminance than a surrounding area.

For example, a region existing on the solder 50 and having dark luminance extends in the directions of arrows C and D in FIG. 11, but the vertex portion 3 does not exist ahead the region having dark luminance. On the other hand, a region having dark luminance extends in the direction of arrow B in FIG. 11, and the vertex portion 3 exists ahead the region having dark luminance. Furthermore, for example, in the directions of arrows F and G in FIG. 11, the outline 51 of the electrode 6 is observed as a region having dark luminance due to the illumination being blocked, but the vertex portion 3 does not exist ahead the region having dark luminance. On the other hand, the vertex portion 3 exists ahead in the direction of arrow E.

As described above, tracking of a region having dark luminance is started from a region existing on the wire bonding portion 2 and having bright luminance, and a determination is made as follow. When the vertex portion 3 exists ahead the region having dark luminance, the region having dark luminance is determined to be the aluminum wire 1, and when the vertex portion 3 does not exist ahead the region having dark luminance, the region having dark luminance is determined not to be the aluminum wire 1. By these determinations, the entire shape of the aluminum wire 1 can be accurately grasped.

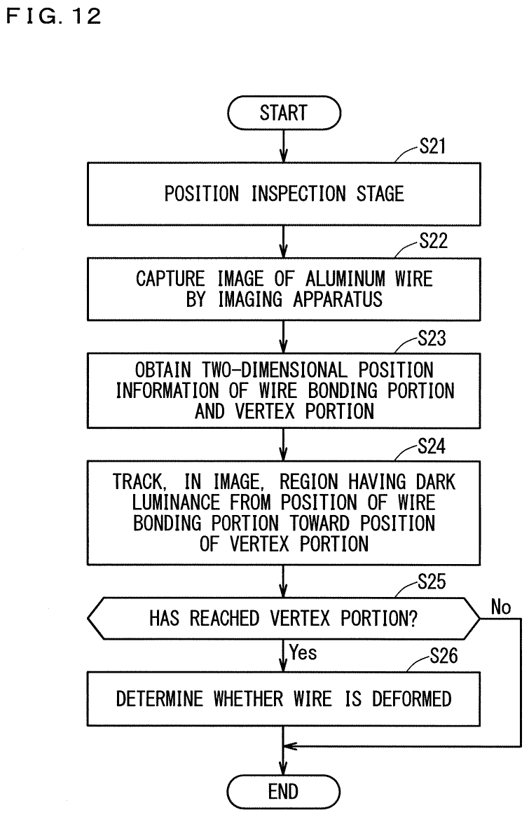

Next, an inspection method according to the fourth preferred embodiment will be described. FIG. 12 is a flowchart of the inspection method according to the fourth preferred embodiment.

As illustrated in FIG. 12, first, the control apparatus 301 positions the inspection stage 201 at a predetermined position (step S21), and captures an image of the aluminum wire 1 by the imaging apparatus 105 (step S22). The control apparatus 301 obtains, from the image captured by the imaging apparatus 105, two-dimensional position information of a region existing on the wire bonding portion 2 and having bright luminance and a region existing on the vertex portion 3 and having bright luminance (step S23).

The control apparatus 301 tracks, in the image, a region having dark luminance from the position of the wire bonding portion 2 toward the position of the vertex portion 3 (step S24). If the vertex portion 3 exists ahead in the direction of the tracking (step S25: Yes), the control apparatus 301 determines that the region having dark luminance and having been tracked is the aluminum wire 1.

On the other hand, if the vertex portion 3 does not exist ahead in the direction of the tracking and the region having dark luminance reaches an end (step S25: No), the control apparatus 301 determines that the region having dark luminance and having been tracked is not the aluminum wire 1.

Finally, the control apparatus 301 determines whether the wire is deformed or not, on the basis of the shape of the region having dark luminance and having been determined to be the aluminum wire 1 (step S26). For example, the control apparatus 301 compares the acquired shape of the aluminum wire 1 with the shape of the aluminum wire 1 previously set in the memory of the control apparatus 301, and when there is a certain difference or more, the control apparatus 301 determines that the wire is deformed, and when there is not a certain difference or more, the control apparatus 301 determines that the wire is not deformed.

In the first preferred embodiment, the presence or absence of wire deformation is determined using, as the shape of the aluminum wire 1, only the two-dimensional position information of the wire bonding portion 2 and the vertex portion 3. However, in the fourth preferred embodiment, also the shape of a portion, of the aluminum wire 1, other than the wire bonding portion 2 and the vertex portion 3 is accurately grasped, so that it is possible to more accurately determine whether the wire is deformed.

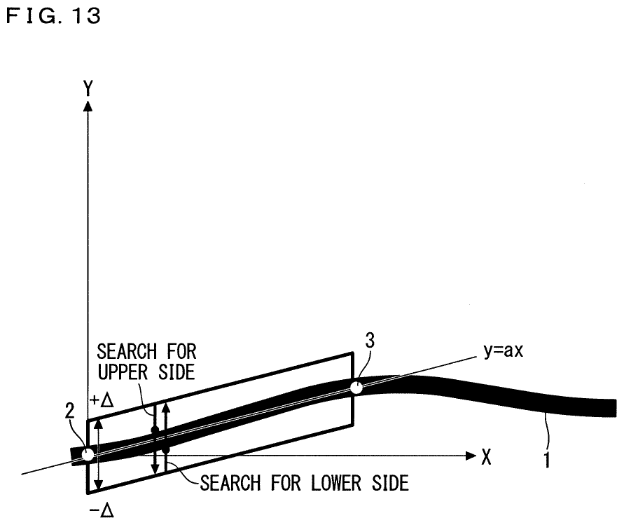

Here, a detailed description will be given on a method of tracking a region having dark luminance that is performed by the control apparatus 301 in step S24. FIG. 13 is an explanatory diagram for explaining an inspection method according to the fourth preferred embodiment.

The control apparatus 301 acquires, from the image, luminance data of pixels in addition to the two-dimensional coordinate information. The image includes numerical values of luminance as many as the number of pixels (represented by a formula: a vertical pixel number×a horizontal pixel number), and a smaller value of luminance data represents darker luminance, and a larger value of luminance represents brighter luminance. For example, in the case of 8-bit luminance data, the luminance of each pixel is represented by a numerical value of 0 to 255.

When the control apparatus 301 acquires the image illustrated in FIG. 11, a straight line extending from the wire bonding portion 2 to the vertex portion 3 is calculated, and FIG. 13 illustrates a state where the straight line is superposed on the image in FIG. 11 with the wire bonding portion 2 as the origin. The shape of the aluminum wire 1 is searched for in the range of −Δ to +Δ (in the frame in FIG. 13) in the Y-axis direction previously set in the Y-axis direction with respect to the pixels overlapping the obtained straight line (y=ax).

First, starting from the origin (wire bonding portion 2) at the left end, the control apparatus 301 first searches for the upper side of the aluminum wire 1. In the searching for the upper side, a change in luminance is checked in the −Y direction in the range of the frame from the position of +Δ in the Y-axis direction with respect to the origin. The change in luminance is checked in the direction of the searching for the upper side, and when a point is found at which the luminance changes from white to black and at which the luminance changes by a previously set luminance or more, the point is determined as the position of the upper side of the aluminum wire 1.

Next, the control apparatus 301 searches for the lower side of the aluminum wire 1. In the searching for the lower side, a change in luminance is checked in the Y direction in the range of the frame from the position of −Δ in the Y-axis direction with respect to the origin. The change in luminance is checked in the direction of the searching for the lower side, and when a point is found at which the luminance changes from white to black and at which the luminance changes by a previously set luminance or more, the point is determined as the position of the lower side of the aluminum wire 1.

The distance between the point determined as the position of the upper side and the point determined as the position of the lower side of the aluminum wire 1 is calculated, and when the distance is within a thickness range of the aluminum wire 1 previously set in the memory of the control apparatus 301, it is determined that the detected upper side and lower side of the aluminum wire 1 are correctly detected.

These processes are repeatedly performed between the wire bonding portion 2 and the vertex portion 3, and the detected upper sides and lower sides of the aluminum wire 1 represent the shape of the aluminum wire 1. If the distance between the upper side and the lower side of the aluminum wire 1 is out of the range of the thickness of the aluminum wire 1 previously set in the memory of the control apparatus 301, it is considered that data is missing.

As described above, in the inspection apparatus according to the fourth preferred embodiment, the control apparatus 301 detects the two-dimensional shape of the aluminum wire 1 by tracking, in the image, the region having darker luminance than the surrounding area from the position of the wire bonding portion 2 toward the position of the vertex portion 3.

Therefore, since the entire shape of the aluminum wire 1 can be accurately grasped, inspection accuracy regarding the deformation of the aluminum wire 1 is improved as compared with the case of the first preferred embodiment.

Note that, the preferred embodiments can be arbitrarily combined, and each preferred embodiment can be appropriately modified or omitted.

Hereinafter, various aspects of the present disclosure will be collectively described as appendices.

### (Appendix 1)

An inspection apparatus that detects abnormality in an inspection workpiece whose both end portions are wire-bonded to to-be-bonded portions of a semiconductor device by a wedge bonding method, wherein the inspection workpiece is a wire having a diameter of 100 μm or more, the inspection apparatus comprising:
an imaging apparatus that is disposed above the wire and captures an image of the wire to obtain two-dimensional position information of the wire;
a coaxial illuminator that is disposed coaxially with the imaging apparatus and applies coaxial illumination light to the wire; and
a control apparatus that obtains, from the image, the two-dimensional position information of a region existing on a vertex portion of the wire and having brighter luminance than a surrounding area and a region existing on a wire bonding portion and having brighter luminance than a surrounding area, the wire bonding portion being a bonding portion of the wire.

### (Appendix 2)

The inspection apparatus according to Appendix 1, wherein
the control apparatus compares the obtained two-dimensional position information of the region existing on the vertex portion and having brighter luminance than the surrounding area and of the region existing on the wire bonding portion and having brighter luminance than the surrounding area and a previously set two-dimensional position information of the vertex portion and of the wire bonding portion, and when there is a certain difference or more, the control apparatus determines that the wire is deformed or that the bonding position is abnormal.

### (Appendix 3)

The inspection apparatus according to Appendix 1, further comprising:
a laser displacement meter that is disposed above the wire and measures a height position of the wire; and
a moving mechanism that moves the semiconductor device in a two-dimensional direction,
wherein
the moving mechanism moves the semiconductor device such that the laser displacement meter is positioned above the wire bonding portion, and
the laser displacement meter measures a height position of the wire bonding portion by applying a laser to a region existing on the wire bonding portion and having brighter luminance than a surrounding area.

### (Appendix 4)

The inspection apparatus according to Appendix 3, comprising two of the laser displacement meters,
wherein the two of the laser displacement meters measure, by measuring the height position of the wire bonding portion while applying a laser of a first one of the laser displacement meters to the portion existing on the wire bonding portion and having brighter luminance than the surrounding area, and at a same time, measuring a height position of a portion, of the semiconductor device, located near the wire bonding portion while applying a laser of a second one of the laser displacement meters to the portion of the semiconductor device, a difference between the height position of the wire bonding portion and the height position of the portion of the semiconductor device.

### (Appendix 5)

The inspection apparatus according to Appendix 1, wherein
the inspection workpiece includes a plurality of wires having a diameter of 100 μm or more,
the control apparatus:
   obtains, from the image, the two-dimensional position information of the region existing on the vertex portion of each of a plurality of the wires and having brighter luminance than the surrounding area;
   measures, from the obtained two-dimensional position information, a distance between a plurality of the vertex portions of the plurality of the wires; and
   compares the distance between the vertex portions with a previously set distance between the plurality of the vertex portions.

### (Appendix 6)

The inspection apparatus according to Appendix 1, wherein the control apparatus detects a two-dimensional shape of the wire by tracking, in the image, a region having darker luminance than a surrounding area from a position of the wire bonding portion toward a position of the vertex portion.

### (Appendix 7)

An inspection method of detecting abnormality in an inspection workpiece whose both end portions are wire-bonded to to-be-bonded portions of a semiconductor device by a wedge bonding method, wherein the inspection workpiece is a wire having a diameter of 100 μm or more, the inspection method comprising:
capturing an image of the wire to obtain two-dimensional position information of the wire, by an imaging apparatus from above the wire;
applying, coaxially with the imaging apparatus, coaxial illumination light to the wire; and
obtaining, from the image, the two-dimensional position information of a region existing on a vertex portion of the wire and having brighter luminance than a surrounding area and a region existing on a wire bonding portion and having brighter luminance than a surrounding area, the wire bonding portion being a bonding portion of the wire.

### (Appendix 8)

The inspection method according to Appendix 7, wherein,
after the obtaining of the two-dimensional position information, a comparison is made between the obtained two-dimensional position information of the region existing on the vertex portion and having brighter luminance than the surrounding area and of the region existing on the wire bonding portion and having brighter luminance than the surrounding area and a previously set two-dimensional position information of the vertex portion and of the wire bonding portion, and
when there is a certain difference or more, a determination is made that the wire is deformed or that the bonding position is abnormal.

### (Appendix 9)

The inspection method according to Appendix 7, further comprising, after the obtaining of the two-dimensional position information:
measuring a height position of the wire from above the wire by a laser displacement meter; and
moving the semiconductor device in a two-dimensional direction,
wherein,
in the moving of the semiconductor device in the two-dimensional direction, the semiconductor device is moved such that the laser displacement meter is positioned above the wire bonding portion, and
in the measuring of the height position of the wire, a height position of the wire bonding portion is measured by applying a laser to a region existing on the wire bonding portion and having brighter luminance than a surrounding area.

### (Appendix 10)

The inspection method according to Appendix 9, wherein
the measuring of the height position of the wire is performed by two of the laser displacement meters, and
the two of the laser displacement meters measure, by measuring the height position of the wire bonding portion while applying a laser of a first one of the laser displacement meters to the portion existing on the wire bonding portion and having brighter luminance than the surrounding area, and at a same time, measuring a height position of a portion, of the semiconductor device, located near the wire bonding portion while applying a laser of a second one of the laser displacement meters to the portion of the semiconductor device, a difference between the height position of the wire bonding portion and the height position of the portion of the semiconductor device.

### (Appendix 11)

The inspection method according to Appendix 7, wherein
the inspection workpiece includes a plurality of wires having a diameter of 100 μm or more, and
in the obtaining of the two-dimensional position information:
the two-dimensional position information of the region existing on the vertex portion of each of a plurality of the wires and having brighter luminance than the surrounding area is obtained from the image;
a distance between a plurality of the vertex portions of the plurality of the wires is measured from the obtained two-dimensional position information; and
the distance between the vertex portions is compared with a previously set distance between the plurality of the vertex portions.

### (Appendix 12)

The inspection method according to Appendix 7, further comprising, after the obtaining of the two-dimensional position information, detecting a two-dimensional shape of the wire by tracking, in the image, a region having darker luminance than a surrounding area from a position of the wire bonding portion toward a position of the vertex portion.

While the disclosure has been shown and described in detail, the foregoing description is in all aspects illustrative and not restrictive. It is therefore understood that numerous modifications and variations can be devised.

What is claimed is:

1. An inspection apparatus that detects abnormality in an inspection workpiece whose both end portions are wire-bonded to to-be-bonded portions of a semiconductor device by a wedge bonding method, wherein the inspection workpiece is a wire having a diameter of 100 μm or more, the inspection apparatus comprising:
an imaging apparatus that is disposed above the wire and captures an image of the wire to obtain two-dimensional position information of the wire;
a coaxial illuminator that is disposed coaxially with the imaging apparatus and applies coaxial illumination light to the wire; and
a control apparatus that obtains, from the image, the two-dimensional position information of a region existing on a vertex portion of the wire and having brighter luminance than a surrounding area and a region existing on a wire bonding portion and having brighter luminance than a surrounding area, the wire bonding portion being a bonding portion of the wire.

2. The inspection apparatus according to claim 1, wherein
the control apparatus compares the obtained two-dimensional position information of the region existing on the vertex portion and having brighter luminance than the surrounding area and of the region existing on the wire bonding portion and having brighter luminance than the surrounding area and a previously set two-dimensional position information of the vertex portion and of the wire bonding portion, and
when there is a certain difference or more, the control apparatus determines that the wire is deformed or that the bonding position is abnormal.

3. The inspection apparatus according to claim 1, further comprising:
a laser displacement meter that is disposed above the wire and measures a height position of the wire; and
a moving mechanism that moves the semiconductor device in a two-dimensional direction,
wherein
the moving mechanism moves the semiconductor device such that the laser displacement meter is positioned above the wire bonding portion, and
the laser displacement meter measures a height position of the wire bonding portion by applying a laser to a region existing on the wire bonding portion and having brighter luminance than a surrounding area.

4. The inspection apparatus according to claim 3, comprising two of the laser displacement meters,
wherein the two of the laser displace meters measure, by measuring the height position of the wire bonding portion while applying a laser of a first one of the laser displacement meters to the region existing on the wire bonding portion and having brighter luminance than the surrounding area, and at a same time, measuring a height position of a portion, of the semiconductor device, located near the wire bonding portion while applying a laser of a second one of the laser displacement meters to the portion of the semiconductor device, a difference between the height position of the wire bonding portion and the height position of the portion of the semiconductor device.

5. The inspection apparatus according to claim 1, wherein
the inspection workpiece includes a plurality of wires having a diameter of 100 μm or more,
the control apparatus:
obtains, from the image, the two-dimensional position information of the region existing on the vertex portion of each of a plurality of the wires and having brighter luminance than the surrounding area;
measures, from the obtained two-dimensional position information, a distance between a plurality of the vertex portions of the plurality of the wires; and
compares the measured distance between the vertex portions with a previously set distance between the plurality of the vertex portions.

6. The inspection apparatus according to claim 1, wherein the control apparatus detects a two-dimensional shape of the wire by tracking, in the image, a region having darker luminance than a surrounding area from a position of the wire bonding portion toward a position of the vertex portion.

7. An inspection method of detecting abnormality in an inspection workpiece whose both end portion are wire-bonded to to-be-bonded portions of a semiconductor device by a wedge bonding method, wherein the inspection workpiece is a wire having a diameter of 100 μm or more, the inspection method comprising:
capturing an image of the wire to obtain two-dimensional position information of the wire, by an imaging apparatus from above the wire;
applying, coaxially with the imaging apparatus, coaxial illumination light to the wire; and
obtaining, from the image, the two-dimensional position information of a region existing on a vertex portion of the wire and having brighter luminance than a surrounding area and a region existing on a wire bonding portion and having brighter luminance than a surrounding area, the wire bonding portion being a bonding portion of the wire.

8. The inspection method according to claim 7, wherein,
after the obtaining of the two-dimensional position information, a comparison is made between the obtained two-dimensional position information of the region existing on the vertex portion and having brighter luminance than the surrounding area and of the region existing on the wire bonding portion and having brighter luminance than the surrounding area and a previously set two-dimensional position information of the vertex portion and of the wire bonding portion, and
when there is a certain difference or more, a determination is made that the wire is deformed or that the bonding position is abnormal.

9. The inspection method according to claim 7, further comprising, after the obtaining of the two-dimensional position information:
measuring a height position of the wire from above the wire by a laser displacement meter; and
moving the semiconductor device in a two-dimensional direction,
wherein
in the moving of the semiconductor device in the two-dimensional direction, the semiconductor device is moved such that the laser displacement meter is positioned above the wire bonding portion, and
in the measuring of the height position of the wire, a height position of the wire bonding portion is measured by applying a laser to a region existing on the wire bonding portion and having brighter luminance than a surrounding area.

10. The inspection method according to claim 9, wherein
the measuring of the height position of the wire is performed by two of the laser displacement meters, and
the two of the laser displacement meters measure, by measuring the height position of the wire bonding portion while applying a laser of a first one of the laser displacement meters to the region existing on the wire bonding portion and having brighter luminance than the surrounding area, and at a same time, measuring a height position of a portion, of the semiconductor device, located near the wire bonding portion while applying a laser of a second one of the laser displacement meters to the portion of the semiconductor device, a difference between the height position of the wire bonding portion and the height position of the portion of the semiconductor device.

11. The inspection method according to claim 7, wherein
the inspection workpiece includes a plurality of wires having a diameter of 100 μm or more, and
in the obtaining of the two-dimensional position information:
the two-dimensional position information of the region existing on the vertex portion of each of a plurality of the wires and having brighter luminance than the surrounding area is obtained from the image;
a distance between a plurality of the vertex portions of the plurality of the wires is measured from the obtained two-dimensional position information; and
the measured distance between the vertex portions is compared with a previously set distance between the plurality of the vertex portions.

12. The inspection method according to claim 7, further comprising, after the obtaining of the two-dimensional position information, detecting a two-dimensional shape of the wire by tracking, in the image, a region having darker luminance than a surrounding area from a position of the wire bonding portion toward a position of the vertex portion.
